(19) United States
(12) Patent Application Publication
(10) Pub. No.: US 2011/0298245 A1
(43) Pub. Date: Dec. 8, 2011

(54) REDUCED HEIGHT PICKUP TRUCK BED SUPPORT AND METHOD OF MANUFACTURING

(75) Inventors: Corey John Jarocki, Harrison Township, MI (US); Andrew Charles Samyn, Dearborn, MI (US); William Sharkey, Troy, MI (US); Matthew Harmon, Dearborn, MI (US); Henry W. Hausler, Manchester, MI (US)

(73) Assignee: FORD GLOBAL TECHNOLOGIES, LLC, Dearborn, MI (US)

(21) Appl. No.: 12/796,210

(22) Filed: Jun. 8, 2010

(51) Int. Cl. B62D 25/20; B23P 11/00

(52) U.S. Cl. 296/193.07; 29/432

(57) ABSTRACT

A pickup bed support structure that includes longitudinally extending frame rails to which transversely extending beams used to support the truck bed box are assembled. The beams are received below a top surface of the frame rails by forming notches or holes in the frame rails into which the beams are inserted. Alternatively, notches or holes may be provided in the transversely extending beams that receive the longitudinal extending frame rails. One method of manufacturing a pickup truck bed support structure is disclosed in which holes are provided in the longitudinally extending frame rail that receive the transversely extending beam that support the pickup truck bed. An alternative method is also disclosed in which notches are formed in the frame rails that receive the beams that are welded to the frame rails prior to assembling the pickup truck bed to the beams.

### BACKGROUND

1. Technical Field

The present invention relates to a reduced height pickup truck bed support structure and method of manufacturing a pickup truck bed structure.

2. Background Art

Pickup trucks are popular vehicles for work and personal use that have a cargo box including a truck bed that is assembled to the vehicle behind a passenger compartment. Pickup trucks are popular because they can be used to haul cargo conveniently while also offering a comfortable passenger compartment, or pickup truck cab.

Pickup trucks have a cargo box and floor that are closed by a tailgate that is folded down to provide access to the pickup truck box. At times it is preferred to load the pickup truck bed box from the side. One problem associated with loading a pickup truck bed from the side is that the height of the side wall of the cargo box makes it difficult for persons to lift cargo into the box from the side. One way of reducing the height of the side wall of the cargo box is to reduce the height of the side wall. However, reducing the height of the side wall may also reduce the cargo carrying capacity of the cargo box.

The height of the load floor of the cargo box raises the height of the load carried in the cargo box which raises the center of gravity of the truck. The center of gravity of a vehicle affects handling and vehicle suspension performance. Generally, it is preferred to reduce the center of gravity of a truck to improve ride and handling.

These and other problems are addressed by Applicants' invention as summarized below.

### SUMMARY

A pickup truck having an improved cargo box or truck bed support structure reduces the height required for a customer to lift cargo into the pickup truck bed. A reduced height offers advantages for loading the pickup truck from the side or from the rear. In addition, the improved pickup truck bed support structure will lower the center of gravity for the cargo box and its contents while maintaining the same volume of cargo carrying space.

Some of the benefits of the improved pickup truck bed support structure is that a lower bed floor may be provided and the step up height required for customers to access the cargo box is reduced. Another benefit associated with the improved pickup truck bed support structure is that the center of gravity of the truck may be lowered that in turn improves the static stability factor.

According to one aspect of the present invention, an improved pickup truck bed support structure is provided in which a pair of frame rails extend longitudinally and inboard of the sides of the bed. The truck bed box is supported by a plurality of transversely extending beams that are assembled to a bottom side of the bed. The frame rails define a plurality of openings that receive the transverse beams below the top surface of the frame rails.

According to another aspect of the present invention, an alternative embodiment of a pickup bed support structure is disclosed wherein a pair of longitudinally extending frame rails receive a plurality of transverse beams that are assembled to the bottom side of the pickup truck bed. The beams each define a plurality of openings that receive the frame rails with the beams being partially disposed below a top surface of the frame rails.

According to yet another aspect of the present invention, a method of manufacturing a pickup truck support structure is provided that is supported by two longitudinally extending frame rails. The method comprises forming a hole in an outer side wall of an outer C-channel of an outer rail of each frame rail. A notch is formed through an upper wall and partially through an inner side wall of an inner C-channel of an inner rail of each of the frame rails. The inner rail is assembled to the outer rail with the hole aligned with the notch of the C-channel of each of the frame rails. A beam is inserted in the transverse direction through the hole and notch of each of the frame rails. The beam or beams are then welded to each of the frame rails adjacent to the hole and the notch. A pickup truck bed is then assembled to the beams after the beams are inserted in and welded to the frame rails.

According to another method of manufacturing a pickup truck support structure is supported by two longitudinally extending frame rails comprising forming a first notch extending through an upper wall and partially through an inner side wall and an outer C-channel of an outer rail of each of the frame rails. A second notch is formed to extend through an inner upper wall and partially through an inner side wall of an inner C-channel of an inner rail of each of the frame rails. The inner rail is assembled to the outer rail with the notches of each of the frame rails in alignment. A beam is inserted into the notches of the frame rails and welded to the frame rails where the beam is disposed adjacent to the notch. The pickup truck bed is then assembled to the beam or beams.

These and other aspects of the present invention will be better understood in view of the attached drawings and the following detailed description of the illustrated embodiments.

### BRIEF DESCRIPTION OF THE DRAWINGS

FIG. 1 is a side elevation view of a pickup truck.

FIG. 2 is a right rear upper perspective view of the frame rails and bed support beams shown assembled together.

FIG. 3 is a right rear lower perspective view of a pickup truck bed box, frame rails and bed support beams shown assembled together.

FIG. 4 is a fragmentary side elevation view of a frame rail and bed support beams.

FIG. 5 is a transverse cross-sectional view of a pickup truck bed, frame rails and a transverse bed support beam.

FIG. 6 is an exploded perspective view for a pickup truck bed, transverse bed support beams and a pair of frame rails.

FIG. 7 is a fragmentary exploded perspective view of a two-part frame rail.

FIG. 8 is a fragmentary perspective view of a frame rail with a bed support beam shown ready for insertion into an opening in the frame rail.

FIG. 9 is a fragmentary perspective view of a frame rail and bed support rail assembled together.

FIG. 10 is an exploded fragmentary perspective view of an alternative embodiment of a frame rail.

FIG. 11 is a fragmentary perspective view of a frame rail made according to the embodiment of FIG. 10 with a bed support beam ready for assembly to a slot in the frame rail.

FIG. 12 is a fragmentary perspective view of a bed support beam shown attached to a frame rail.

FIG. 13 is a fragmentary exploded perspective view of an alternative bed support structure in which the bed support beam is notched to receive a frame rail.

FIG. 14 is a fragmentary perspective view of the bed support structure shown in FIG. 13 after assembly and welding.

### DETAILED DESCRIPTION

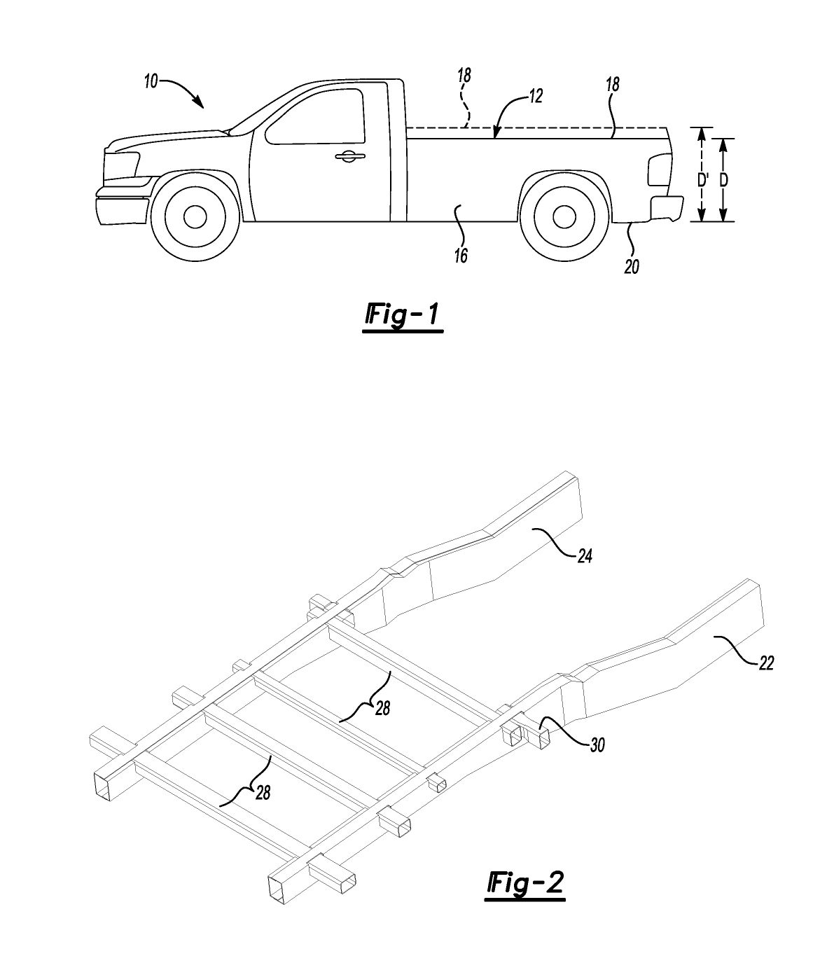

Referring to FIG. 1, a truck 10, for example a pickup truck, is shown that includes a cargo box 12. The cargo box 12 has a side wall 16 that has a top edge 18. The top edge 18 of the side wall 16 is shown with a lower top edge as compared to the higher top edge 18 shown in phantom lines. The depth of the box indicated by D is measured from the bottom of the chassis 20 to the top edge 18. The depth D′ of a higher profile cargo box 12 is also indicated.

Referring to FIG. 2, a right frame rail 22 and a left frame rail 24 extend in a longitudinal vehicle direction. Bed frame beams 28 extend in a transverse vehicle direction through the right and left frame rails 22 and 24. One of the frame rails has an additional section and may be referred to as a shock support rail 30.

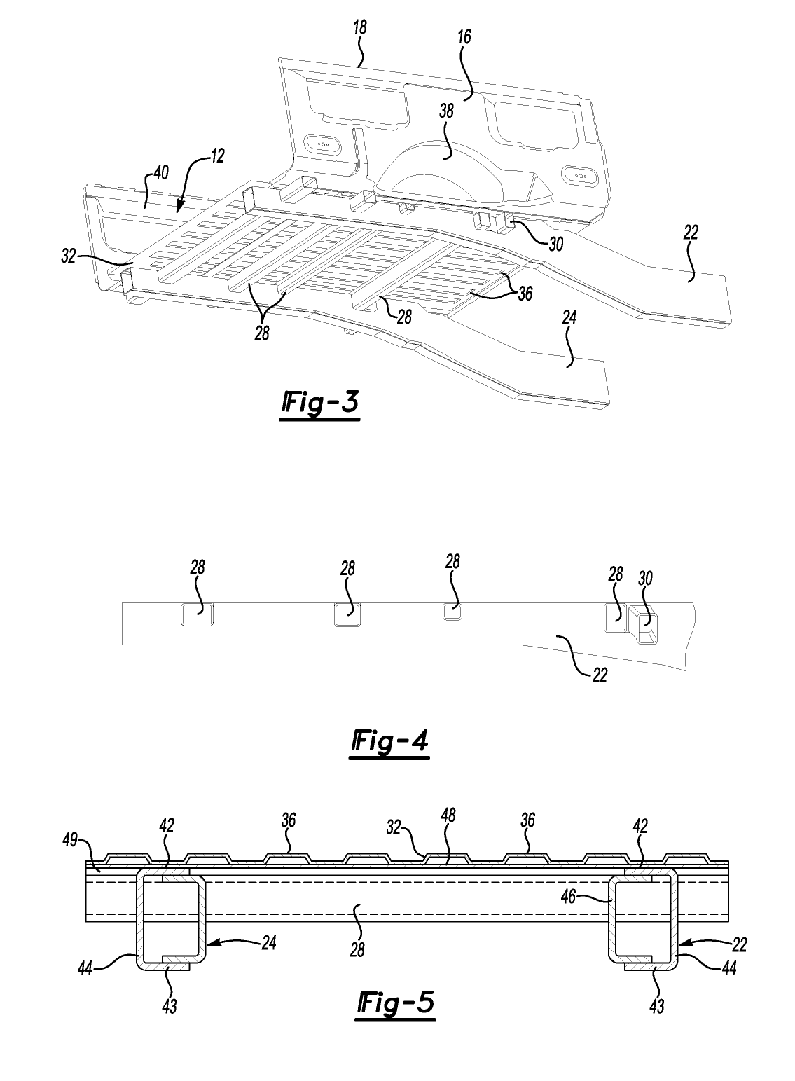

Referring to FIG. 3, a cargo box 12 is shown assembled to the frame rails 22 and 24 and bed frame beams 28. The truck bed 32 in the bottom of the cargo box 12 is provided with a plurality of stiffening ribs 36 that extend in the longitudinal vehicle direction. A wheel housing 38 forms part of an inner side wall 40 of the cargo box 12.

Referring to FIG. 4, a plurality of bed frame rails 28 are inserted transversely through the right frame rail 22.

Referring to FIG. 5, a truck bed 32 is shown assembled to a top wall 42 of the left and right frame rails 22 and 24. The frame rails also have a bottom wall 43. The frame rails each include an outer C-channel 44 and an inner C-channel 46 that are assembled and welded together to form the right and left frame rails 22 and 24. A strap 48 may be provided between truck bed 32 and the right and left frame rails 22 and 24. The strap 48 provides additional support across the truck bed 32.

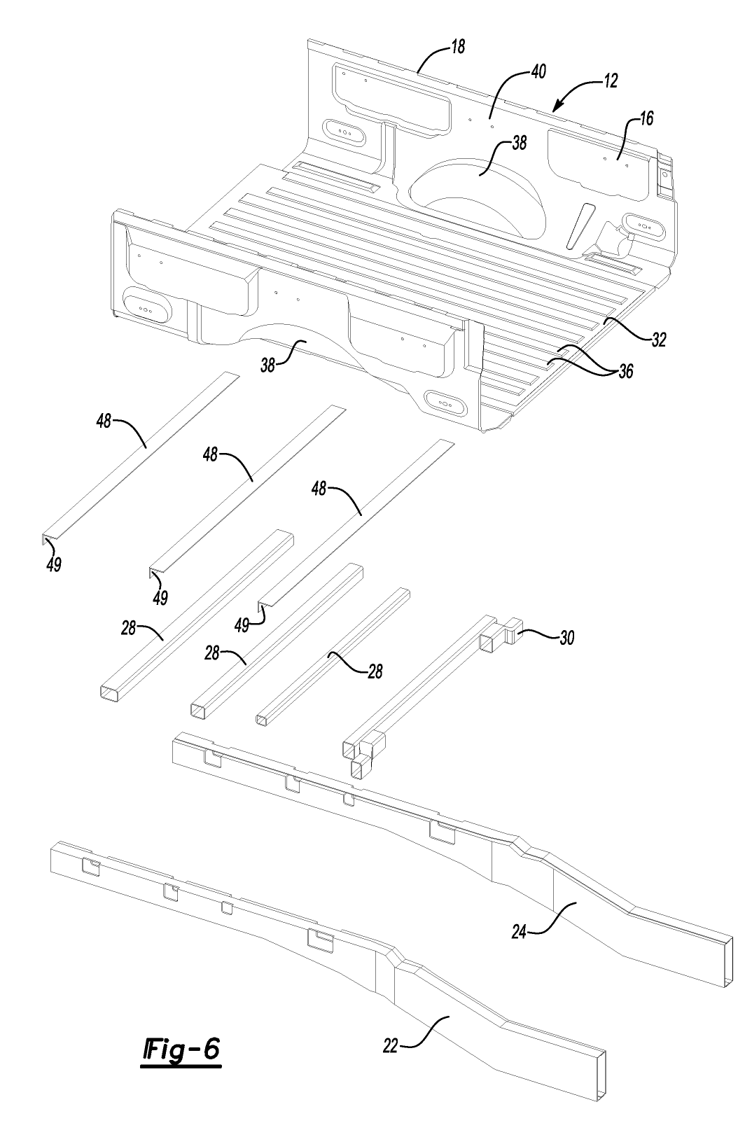

Referring to FIG. 6, a cargo box 12 is shown separated from the bed frame beams 28 that extend in a transverse vehicle direction and the right and left frame rails 22 and 24 that extend in the longitudinal vehicle direction. The side wall 16 has a top edge 18. The portion of the cargo box 12 shown in FIG. 6 is the inner side wall 40 of the truck bed 32. It should be understood that outer side walls and a front and a rear tailgate are to be provided to complete the structure of the cargo box 12. The truck bed 32 is reinforced by the straps 48 that extend in the transverse vehicle direction across the bottom of the truck bed 32. The bed frame beams 28 are inserted through the right and left frame rails 22 and 24, as will be described more specifically with reference to FIGS. 7-9 below.

Referring to FIG. 7, left frame rail 24 is shown split into an outer C-channel 44 and an inner C-channel 46. An opening 50 is formed in the outer C-channel 44 through a side wall 52 of the outer C-channel 44. A top corner 54 of the outer C-channel 44 is removed and forms part of the opening 50 that extends into the top wall 42. The opening 50 may be formed in a flat blank that is formed by a press or roll former to have a bottom wall 43 and a top wall 42. A slot 56 is formed in the inner C-channel 46. Slot 56 extends through the top wall 58 and side wall 60 of the inner C-channel 46. The inner C-channel 46 also has a bottom wall 59. The inner and outer C-channels 44 and 46 are assembled together and welded at the top walls 42, 58 and bottom walls 43, 59 to form the left frame rail 24.

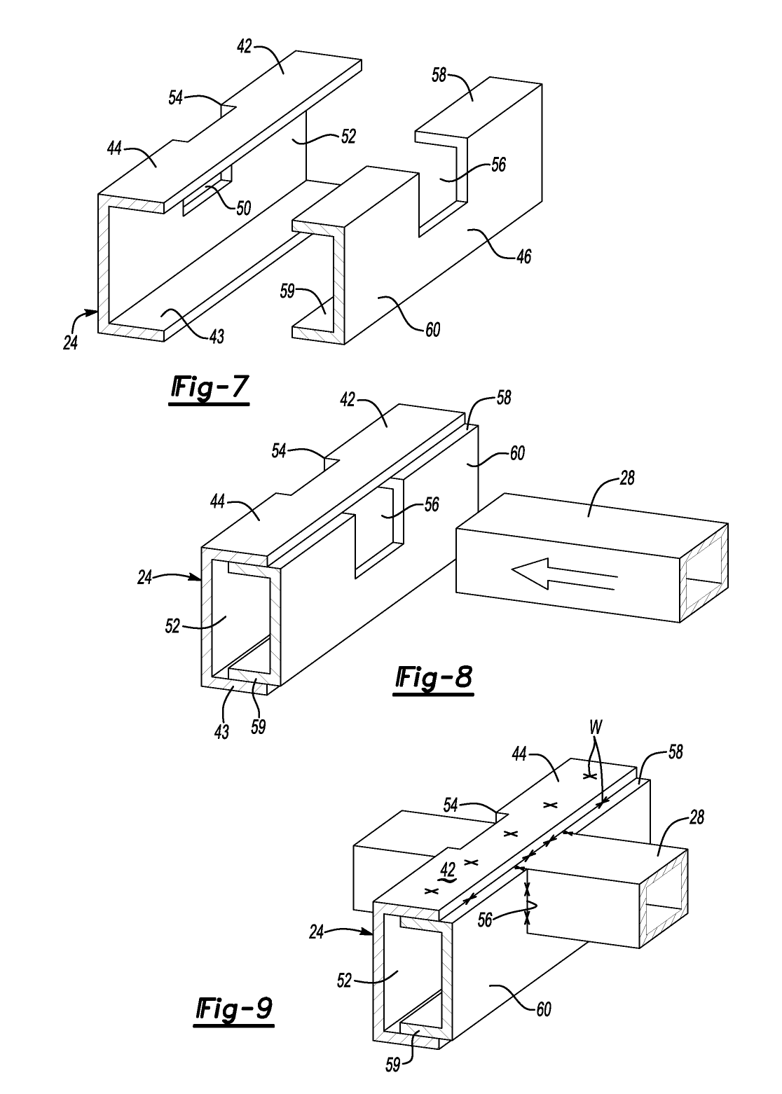

The bed frame beam 28 is inserted through the left frame rail 24, as shown in FIG. 8. The bed frame beam 28 is inserted in the transverse vehicle direction as shown by the arrow on the side of the bed frame beam 28 in FIG. 8. The bed frame beam 28 is inserted either from the inside or through the outside of the frame rail 24. The bed frame beam 28 is located below the top wall 42 of the outer C-channel 44. The strap 48 may be secured to the top walls 42 of the outer C-channels 44, 46. A flange 49 may be provided or formed on one of the lateral edges of the straps 48.

Referring to FIG. 9, the left frame rail 24 and a bed frame beam 28 are shown assembled together and welded in place. The bed frame beam 28 extends completely through the left frame rail 24. The outer C-channel 44 and inner C-channel 46 are welded together as shown by the X marks as identified by letter W in FIG. 9. The top walls 42 and 58 of the outer C-channel 44 and inner C-channel 46 may be welded together by a laser weld penetrating the top surfaces or may be welded together by a MIG welding operation with the top wall 42 of the outer C-channel 44 being welded at its end to the top wall 58 of the inner C-channel 46. The bottom walls 43, 59 are welded in a similar manner. The bed frame beam 28 is welded about its periphery where it contacts the edges of the slot 56 in the inner C-channel 46 and also is preferably welded to the opening 50 in the outer C-channel 44. By welding the bed frame beams 28 on both sides to the frame rail 24, the structural integrity of the frame rails is maintained and no substantially weakening of the frame rail is caused by the formation of the opening 50 and slot 56 in respective C-channels 44 and 46.

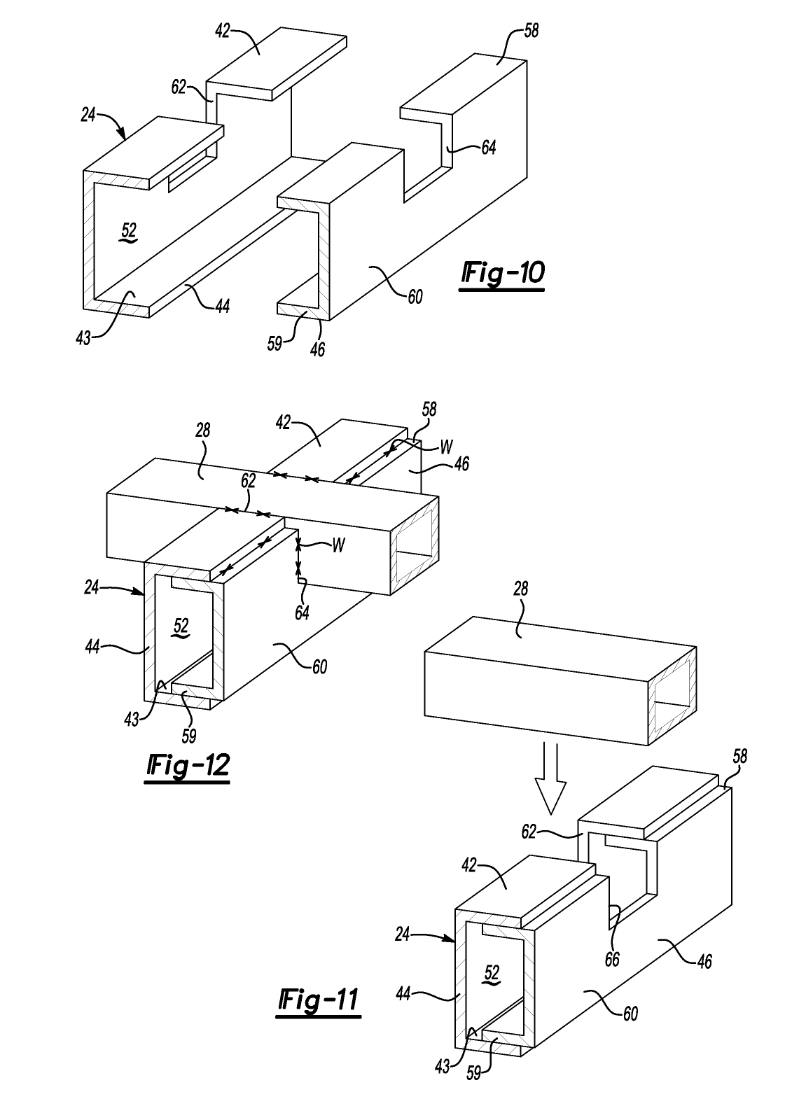

Referring to FIG. 10, an alternative embodiment is shown. The same reference numerals are used to refer to the same parts of frame rail 24. As shown in FIG. 10, an outer C-channel 44 is shown next to inner C-channel 46. A slot 62 is formed in the outer C-channel 44 that extends through the top wall 42. Another slot 64 is formed in the inner C-channel 46 and is in alignment with the slot 62 in the outer C-channel 44. The slot 62 extends through the top wall 42 and partially through the side wall 52 of the outer C-channel 44. The slot 64 is formed in the top wall 58 and partially through the side wall 60 of the inner C-channel 46.

Referring to FIG. 11, the outer C-channel 44 and inner C-channel 46 are shown assembled together with the slots 62 and 64 in alignment. The bed frame beam 28 is shown just prior to assembly into the slots 62 and 64. In this embodiment, the bed frame beam 28 may be attached to the truck bed 32 and then simply dropped into the slots 62 and 64 with the full height of the bed frame beams 28 being disposed fully or substantially below the top wall 42.

Referring to FIG. 12, the bed frame beam 28 is shown assembled to and welded in place on the left frame rail 24. The inner and outer C-channels 44 and 46 are welded together in a MIG welding operation as indicated by the X marks identified by reference letter W. The welds W that secure the inner C-channel 46 to the outer C-channel 44 are formed on the top wall 58 o the inner C-channel 46 and at the end of the top wall 42 of the outer C-channel 44. While only one set of welds is shown, it should be understood that a similar weld construction is provided to join the bottom walls 43 and 59 of the inner and outer C-channels together. Additional welds W are formed between the left frame rail 24 and the bed frame beam 28 around the edges of the slots 62 and 64 in which the bed frame beams 28 are received. By welding substantially completely around the slots 62 and 64 to the bed frame beams 28, the strength of the frame rail 28 is not compromised and a robust cargo box 12 may be provided at a lower height due to the fact that the bed frame beams 28 are received below the top wall 42 of the outer C-channel 44.

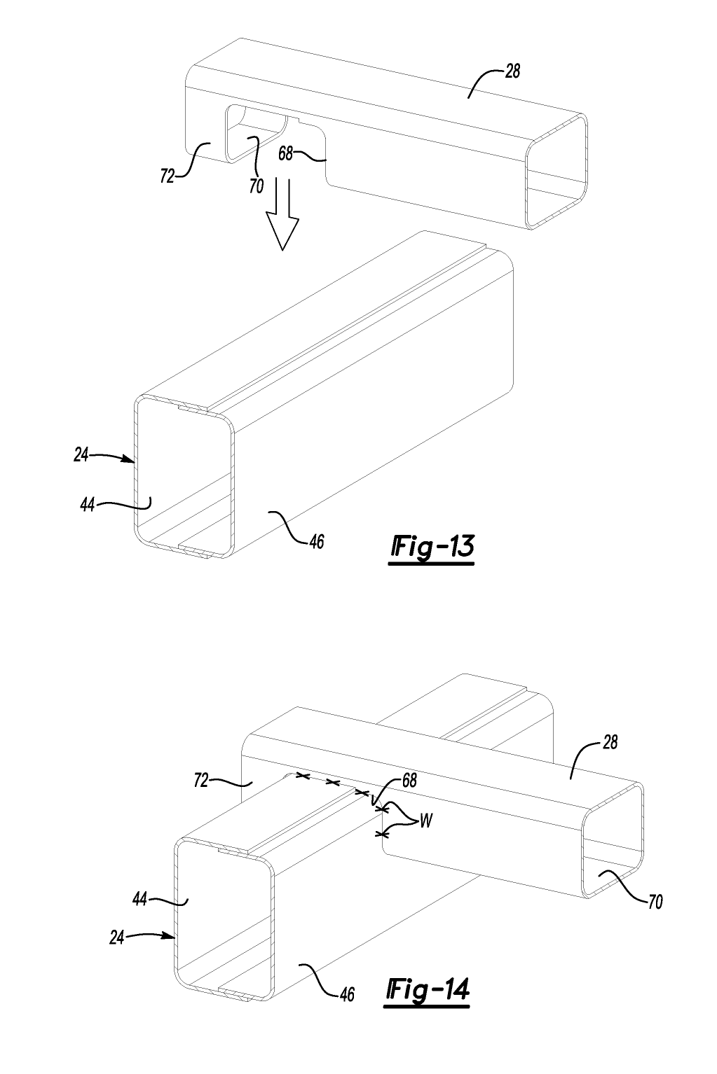

Referring to FIGS. 13 and 14, another alternative embodiment is illustrated that could be used with the bed structure shown in FIGS. 1-6. The beam 28 has a slot 68 formed in a bottom wall 70 and side walls 72 of the beam 28. The left frame rail 46 as shown and right frame rail 44 need not have an opening or slot, but may be received in the slot 68. As another alternative, mating slots (not shown) could be provided in both the beams 28 and frame rails 22 and 24. With either alternative, a lower height truck bed could be provided.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A pick-up truck bed support structure comprising:
a pair of frame rails extending in the longitudinal vehicle direction that are inboard of a pair of sides of a bed portion;
a truck bed box having a plurality of beams that extend transversely across the bed portion and that are assembled to a bottom side of the bed portion; and
wherein the frame rails define a plurality of openings that receive the beams below a top surface of the frame rails.

2. The pick-up truck bed support structure of claim 1 wherein the openings in the frame rails further comprise slots that extend through a top surface of the frame rails to an intermediate portion of the frame rails.

3. The pick-up truck bed support structure of claim 1 wherein the openings in the frame rails are formed below a top surface of the frame rails.

4. The pick-up truck bed support structure of claim 3 wherein the beams are disposed entirely below the top surface of the frame rails.

5. The pick-up truck bed support structure of claim 1 further comprising a plurality of substantially flat straps directly secured to the truck bed box, wherein each of the plurality of beams is attached to the truck bed box through one of the straps.

6. The pick-up truck bed support structure of claim 5 wherein the straps have a pair of laterally extending edges and at least one flange is provided on one of the laterally extending edges.

7. The pick-up truck bed support of claim 1 wherein the beams extend between the frame rails and outboard of both frame rails.

8. The pick-up truck bed support of claim 1 wherein the frame rails are each formed by assembling two C-shaped channels together to provide frame rails with a box shaped cross-section.

9. The pick-up truck bed support of claim 8 wherein the C-shaped channels include an outer channel having an outer side wall, an outer upper wall and an outer lower wall and wherein a first part of one of the openings is formed in the outer side wall in the outer channel, and wherein the C-shaped channels further include an inner channel having an inner side wall, an inner upper wall and an inner lower wall and wherein a second part of said one of the openings is formed in the inner side wall and through the inner upper wall.

10. The pick-up truck bed support of claim 1 wherein the beams are welded to the frame rails around the openings formed in the frame rails.

11. A pick-up truck bed support structure comprising:
a pair of frame rails extending in the longitudinal vehicle direction that are inboard of a pair of sides of a bed portion;
a truck bed box having a plurality of beams that extend transversely across the bed portion and that are assembled to a bottom side of the bed portion; and
wherein the beams each define a plurality of openings that receive the frame rails with the beams being partially disposed below a top surface of the frame rails.

12. The pick-up truck bed support structure of claim 11 wherein the openings in the beams further comprise slots that extend through a bottom surface of the beams and partially through the side walls of the beams.

13. The pick-up truck bed support of claim 11 wherein the beams extend between the frame rails and outboard of both frame rails.

14. The pick-up truck bed support of claim 11 wherein the frame rails are each formed by assembling two C-shaped channels together to define a frame rails having a box shaped cross-section.

15. The pick-up truck bed support of claim 14 wherein the C-shaped channels include an outer channel having an outer side wall, an outer upper wall and an outer lower wall and wherein the outer upper wall and at least part of the outer side wall are received in one of the openings, and wherein the C-shaped channels further include an inner channel having an inner side wall, an inner upper wall and an inner lower wall and wherein the inner upper wall and at least part of the inner side wall are received in one of the openings.

16. The pick-up truck bed support of claim 11 wherein the frame rails are welded to the beams around the openings formed in the beams.

17. A method of manufacturing a pick-up truck support structure that is supported by two frame rails that extend longitudinally in a vehicle, the method comprising:
forming a hole in an outer sidewall of a outer C-channel of an outer rail of each of the frame rails;
forming a notch extending through an upper wall and partially through an inner sidewall of an inner C-channel of an inner rail of each of the frame rails;
assembling the inner rail into the outer rail with the hole and the notch of each of the frame rails being aligned;
inserting a beam in a transverse direction through the hole and the notch of each of the frame rails;
welding the beam to of each of the frame rails where the beam is disposed adjacent the hole and the notch; and
assembling a pick-up truck bed to the beam after the beam is inserted in and welded to the frame rails.

18. The method of claim 17 wherein the step of forming a portion of the hole in the outer side wall of the outer C-channel comprises:
forming a hole that is in the shape of the beam in a blank;
forming an upper wall on one side of the hole and adjacent to the hole; and
forming a lower wall on one side of the hole that is spaced from the hole.

19. The method of claim 17 wherein the step of forming a portion of the hole in the inner side wall of the inner C-channel comprises:
forming a hole in a blank;
forming an upper wall that includes the hole, wherein the hole also extends into a sidewall of the C-channel; and
forming a lower wall on one side of the hole that is spaced from the hole.

20. A method of manufacturing a pick-up truck support structure that is supported by two frame rails that extend longitudinally in a vehicle, the method comprising:
forming a first notch extending through an outer upper wall and partially through an inner sidewall and an outer C-channel of an outer rail of each of the frame rails;
forming a second notch extending through an inner upper wall and partially through an inner sidewall of an inner C-channel of an inner rail of each of the frame rails;
assembling the inner rail into the outer rail with the notches of each of the frame rails being aligned;
inserting a beam into the notch of each of the frame rails;
welding the beam to of each of the frame rails where the beam is disposed adjacent the notch; and
assembling a pick-up truck bed to the beam.
